(19) United States
(12) Patent Application Publication
(10) Pub. No.: US 2020/0174503 A1
(43) Pub. Date: Jun. 4, 2020

(54) DATABASE OF DRONE FLIGHT PLANS FOR AIRCRAFT INSPECTION USING RELATIVE MAPPING

(71) Applicant: SITA Information Networking Computing UK Limited, Middlesex (GB)

(72) Inventors: Stephane CHEIKH, Cointrin (CH); Michael KELLY, Donegal (IE)

(21) Appl. No.: 16/630,747

(22) PCT Filed: Jul. 13, 2018
(86) PCT No.: PCT/GB2018/052007

§ 371 Date: Jan. 13, 2020

(30) Foreign Application Priority Data
Jul. 13, 2017 (GB) 1711261.6

(51) Int. Cl. G05D 1/12; G08G 5/00; G06K 9/00; G06T 7/00; G05D 1/10; B64C 39/02

(52) U.S. Cl. CPC G05D 1/12; G08G 5/0034; G06K 9/00671; G06T 7/001; B64C 2201/123; B64C 39/024; G06T 2207/10032; G06T 2207/30252; G05D 1/101

(57) ABSTRACT

Methods for drone-assisted inspection of aircraft and other large, mobile structures are disclosed. The drone's camera identifies the mobile structure and an inspection routine is selected from available inspection routines. A flight plan is retrieved from a database corresponding to a portion of the identified mobile structure and comprising instructions to visit positions in three-dimensional space corresponding to the points of the structure identified for inspection in the inspection routine. The drone is operated according to the retrieved flight plan and at one or more of the positions visited, data indicative of the condition of corresponding point of the structure is captured. Points of the structure where the condition of the structure appears sub-optimal are identified and their coordinates saved. On completion of the inspection, one of more points identified as sub-optimal is revisited and a further, more detailed inspection is performed under the control of an operator.

### FIELD OF THE INVENTION

This invention relates to the visual inspection of large, valuable, mobile structures, such as aircraft, for damage or other anomalies.

### BACKGROUND

All aircraft, whether commercial or military, must undergo periodic maintenance checks in order to comply with the safety and other regulations and requirements of the relevant administrative authorities. For this purpose, commercial aircraft operators (for example) have in place inspection programs, which may be approved by the Federal Aviation Administration of the United States of America, the European Aviation Safety Agency or some other established authority, to ensure the ongoing airworthiness of each craft in their fleet. Included in these programs are both shorter, lighter inspections of the kind known in the industry as ‘A’ and ‘B’ checks, and much longer, more extensive and exhaustive examinations (‘C’ and ‘D’ checks), which generally require many more of a craft's components to be visually inspected. Most of these approved inspections are typically carried out by taking an aircraft temporarily out of service, either into a hangar or otherwise parked at a suitable spot at an airport, and by making use of small cranes or ‘cherry pickers’ to give engineers access to all of the components of the craft that require examination. The resulting process is often lengthy and laborious: an approved check may take anywhere from tens to thousands of man-hours to complete. The removal of a craft from commission for such a prolonged period of time often comes at great cost to the airline.

(Note that the present discussion is made with reference to aircraft for the sake of concreteness only: as will be apparent, it applies equally to the inspection of cruise ships, tankers, submarines and any other large, mobile, critical vessel or structure.)

Further of relevance to this invention are the ‘pre-flight’ checks of passenger aircraft by the pilot and his crew that are also called for by the airline industry. These comparatively short, visual inspections are typically carried out at the airport gate in the turnaround time between one flight and the next. As such, they are usually limited to the under-wing area of the plane: since there is often no equipment at the gate that affords access to the upper portions of the aircraft, pilots are constrained simply to walk under and around the plane checking to the best of their ability for defects such as fluid leaks, dents or other obvious damage such as obstructions to the pitot tubes and pitot static ports, used to monitor airspeed and altitude during flight.

Recently, proposals have been made to automate aircraft inspection by using dedicated machines, such as camera-equipped unmanned aerial vehicles (UAVs, also referred to herein as ‘drones’), to scan the craft, collecting as they go image and/or video data and feeding these back to engineers who may then scrutinise them remotely. Such solutions promise a significant reduction in the time and effort required for periodic aircraft maintenance checks of the kind introduced above. However, they depend for their success on the provision of a highly precise flight plan (also referred to herein as a ‘mission plan’) for the drone, in order to ensure both that the entirety of a craft is adequately surveyed. In addition, engineers also need to be able to understand the images and information they are receiving in terms of the area of the plane to which they relate; in other words, they require exact knowledge of the position of the drone relative to the craft at any given time. For instance, if an anomaly is detected by zooming in on a particular rivet, then in order to investigate further and ultimately rectify the damage it must be possible to decipher where the fault is situated on the craft as a whole. In this regard, ready access to further images known to relate to the identified affected area may also be desirable; again, a correlation of some description between the specific images collected and the various areas of the craft becomes highly desirable or even indispensable.

At present, drones and other unmanned vehicles are being adopted to assist in the performance of automated tasks such as the surveying of crop fields, mines and quarries, or regular inspections around waypoints. Those solutions might appear as a promising starting point for the application of UAV technology to the inspection of aircraft. However, the software currently being used for planning and executing land surveys using drones is not generally well-suited to the scenario of interest here, as follows.

UAV autopilot systems and software currently make use of mapping tools to enable a user to create a flight plan for the desired survey. The information is typically input as overlay on a geographical map of the region, against which the user can draw out the area to be covered and identify and name specific points at which images are to be taken. Once programmed with the coordinates of the path it is to follow, the drone can make use of real-time positioning capabilities such as GPS to understand in real-time where it is and where it needs to go next. Thus one immediate difficulty in adapting these existing tools for use in the present setting is that the GPS typically relied on in order to execute a drone's mission plan may not be consistently available within a hangar or other covered inspection location. In addition, to meet with the relevant regulations aircraft inspections must be both precise and thorough, with sub-millimetre image resolution and scans taken from a variety of angles to ensure that sufficient, accurate information is collected and that due account is taken of reflections and other systematic or random errors. These considerations are not generally of concern in the automated survey of larger land areas; as a result, the centimetre-level position accuracy required of the UAV is not generally possible with the mapping tools and positioning systems ordinarily adopted to automate field and other surveys. What is more, in order to achieve this level of precision notwithstanding the complexity of an aircraft's three-dimensional shape, a camera-equipped drone must to be able to fly much more closely to the craft's surface than has needed to be considered in previous applications of UAV technology. The negative impact of an accidental collision, when the inherent monetary value of aircraft and the unwelcome delays incurred by any investigation process are borne in mind, make the need for positional accuracy of the drone throughout the inspection flight all the more apparent.

Moreover, since the existing tools mentioned above allow a user to specify a flight plan by overlaying the required path onto a map of the earth, they are of use only when the area or object to be scanned is fixed in its geographical location. Any given aircraft, in contrast, may need to be inspected anywhere on the globe. As a result, even with access to GPS (and even, hypothetically, with the required positional accuracy), reliance on the currently available flight mapping software would necessitate the creation of a new drone flight plan for every instance of a check to be carried out. That approach may be unacceptable or even unfeasible in the light of the complex nature of the inspections to be carried out—and the degree of time and effort involved in the creation of a suitable UAV flight routine as a result—and in view of the existence of hundreds or even thousands of examples of a particular make and model of craft in service at one time.

### SUMMARY OF THE INVENTION

The invention is defined in the independent claims, to which reference should be made. Preferred features are set out in the dependent claims.

We have appreciated that it would be beneficial to facilitate the use of camera-equipped drones for the inspection of aircraft and other large, critical vehicles by providing suitably accessible, accurate and re-usable mission plans, corresponding to the inspection routines commonly implemented in the industry, which such a drone can follow to complete a satisfactory survey of the craft.

Broadly speaking, the present invention addresses this problem by providing a database of flight plans that do not depend on geographical coordinates (that is, on the specification of absolute longitude, latitude and altitude, or LLA) for their definition. Instead, the plans are defined relative to a pre-defined ‘home’ (or ‘start’) position from which it is assumed that the drone will begin its flight, with all waypoints along the inspection path being calculated and programmed with reference to that origin point. In use, the drone may be placed at the appropriate home position by ground staff at the airport.

As will be familiar to those in the industry, there are times at which a detailed inspection of one particular area of a craft is required—such as one of the wings, for instance—while the rest of the vehicle is known to be sound. In such cases, it can be desirable to inspect only the area of interest, so as not to incur the costs in terms of time and effort of surveying the remainder of the craft essentially without due cause. The invention foresees the creation of dedicated mission plans corresponding to these inspection ‘sub-routines’, for storage in the database under a suitable label or identifier.

In one aspect, the invention provides a method for use in automated or semi-automated inspection of a large, mobile structure, such as an aircraft or ship, for compliance with safety regulations using a sensor-equipped UAV. The method includes the steps of accepting a three-dimensional rendering of the structure and accepting a specification of an inspection routine to be carried out. A home position for the UAV relative to the structure is defined, and a flight plan is generated for it. The flight plan includes instructions to visit positions in three-dimensional space that correspond to the points of the structure identified in the accepted inspection routine.

In some embodiments, the instructions of the flight plan include an ordered list of three-dimensional co-ordinates that are specified relative to the home position. In other embodiments, the instructions comprise an ordered list of movements for the UAV to make in three dimensional space, beginning at the home position. In both case, one, some or all of the instructions may further specify that the time at which the UAV is to visit the corresponding point or points.

As discussed in more detail below, the step of generating the flight plan may include a first step of generating a ‘generic’ flight plan, in which one, some or all of the positions that the UAV is to visit are specified as a function of one or more variables corresponding to respective dimensions of the structure. The method may then further include steps of retrieving the numerical values of the dimensions of the particular structure of interest, and using those values to evaluate the function (or functions) to generate a flight plan that is specific to the structure.

In some embodiments, the instructions of the flight plan include instructions to capture image and/or video data at one or more of the positions to be visited.

Preferably, the generated flight plan, once complete, is stored in a suitable database.

In a second aspect, the invention provides a method for automated or semi-automated inspection of a large, mobile structure using a camera-equipped UAV. The method includes the step of using the camera to identify the mobile structure to be inspected; selecting an inspection routine for a portion of the mobile structure from a plurality of available inspection routines; retrieving, from a database a flight plan for the UAV corresponding to the selected inspection routine, the flight plan corresponding to the portion of the identified mobile structure and comprising instructions to visit points in three-dimensional space that correspond to the points of the structure identified in the inspection routine. The method then further includes the steps of operating the UAV according to the retrieved flight plan and, at one or more of the positions visited, capturing data indicative of the corresponding point of the structure; identifying points of the structure where the condition of the structure appears sub-optimal; saving the coordinates of points of the structure so identified; and on completion of the inspection, revisiting one of more points identified as sub-optimal and performing a further inspection under the control of an operator.

Embodiments of this aspect of the invention have the advantage that they enable inspection of only a specified portion of the structure and enable inspection for a specific purpose as identified by the inspection routine that is selected which in turn is dependent on the maintenance record that is retrieved. Where the structure is an aircraft this is very beneficial as it allows aircraft in remote locations to be inspected for damage, following an incident, for example a lightning strike. The inspection may be performed at a location where there are minimal support facilities as the UAV may be controlled remotely.

In some embodiments, the sensor comprises a camera; and the captured data comprise image and/or video data.

Preferably, the captured data are transmitted to an operator for analysis. This may be done substantially in real-time as the data are captured or, alternatively, after the completion of the inspection flight plan.

Preferably, the step of using the camera to identify the mobile structure to be inspected comprises capturing a unique identifier on the structure. The mobile structure may an aircraft and the unique identifier may be the aircraft tail number.

Preferably the flight plan maintains the UAV at a predetermined distance from the surface of the mobile structure, determined by the selected inspection routine. Different inspection routines may require the UAV to be at different distances under the control of the operator.

The step of identifying points of the structure where the condition of the structure appears sub-optimal may be performed automatically by comparison of data retrieved by the camera with pre-stored data for the respective point of the mobile structure. Alternatively it may be performed by a human operator.

This aspect of the invention also resides in a system for automated or semi-automated inspection of a large, mobile structure, comprising: a camera-equipped unmanned aerial vehicle (UAV); a database having stored therein a plurality of inspection routines, and a three-dimensional rendering of a plurality of mobile structures; and a controller, the controller being programmed perform the steps of: controlling the UAV camera to identify the mobile structure to be inspected; selecting an inspection routine for a portion of the mobile structure from a plurality of available inspection routines; retrieving, from the database, a flight plan for the UAV corresponding to the selected inspection routine, the flight plan corresponding to a portion of the identified mobile structure and comprising instructions to visit positions in three-dimensional space corresponding to the points of the structure identified for inspection in the inspection routine; operating the UAV according to the retrieved flight plan; at one or more of the positions visited, capturing data indicative of the condition of corresponding point of the structure; identifying points of the structure where the condition of the structure appears sub-optimal; saving the coordinates of points of the structure so identified; and on completion of the inspection, revisiting one of more points identified as sub-optimal and performing a further inspection under the control of an operator.

### BRIEF DESCRIPTION OF THE DRAWINGS

Embodiments of the invention will now be described, by way of illustrative example only, with reference to the accompanying drawings in which:

FIG. 1 is a flowchart schematically illustrating the creation of a flight plan for a UAV in accordance with an aspect of the invention;

FIG. 2 is a schematic illustration of an inspection flight plan for a UAV, overlaid on a model of the relevant aircraft;

FIG. 3 is a schematic illustration of the flow of data in an exemplary method embodying the invention; and

FIG. 4 is a flow chart illustrating the steps in a further aspect of the invention

### DETAILED DESCRIPTION

In the following, the creation of a flight plan that an unmanned drone can follow so as to complete a desired inspection of a part or a portion of an aircraft according to one embodiment will be described. It will be understood that the inventive method to be described is quite generally applicable; in particular, as conceived it is both airline- and make/model-agnostic. Indeed, as mentioned above the application of the invention extends beyond the inspection of aircraft per se to include that of other large, mobile structures such as submarines, cruise ships and so on.

Examples of the ways in which a flight plan may be adopted in practice so as to complete a chosen inspection will then be illustrated.

Flight Plan Creation

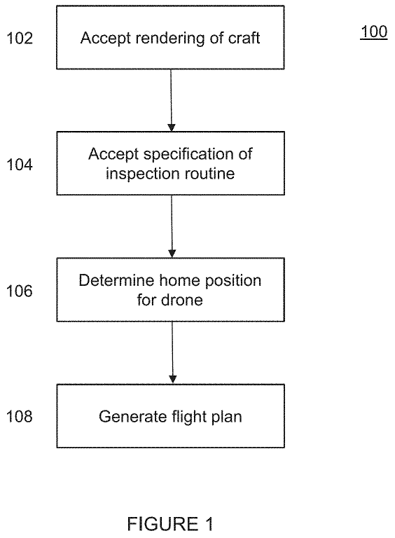

The flowchart of FIG. 1 illustrates schematically the method 100 of creation of a mission plan for a chosen inspection routine according to one embodiment. As shown, the method begins at step 102 with the acceptance of a three-dimensional (3D) rendering of the relevant aircraft. Such a model may be obtained directly from the aircraft manufacturer, for example, and may be in any one of FBX, OBJ, MAX, 3DS or C4D file formats, or any other suitable format.

Also accepted (step 104) is a specification of the inspection routine to which the mission plan is to correspond. It will be appreciated that the order of steps 102 and 104 is immaterial for the present purposes: the information just identified may be obtained in any order or indeed simultaneously.

At step 106, an appropriate start position is chosen to act as the origin x=0 or the home point for the UAV that was mentioned above. To give a concrete example, the flight plan may assume that the drone will begin its inspection routine at the aircraft nose; for example, 1 m directly in front of it. This point may therefore be chosen as the home position; alternatively, the flight plan may be defined relative to an origin that is defined as the point on the ground directly beneath it, the first instruction in that case being to move vertically upward to a point x=(0,0, hₙ), where hₙ is the height of the nose above ground level.

As indicated at step 108, the path that the drone is to follow is then defined through the specification, to a high level of precision and relative to the home position, of an ordered sequence of (three-dimensional) waypoints x to visit. As well as that basic route, the plan also includes instructions as to where the drone should pause to capture image data, which may specify the appropriate camera angles/directions to use, number of images to take, and any other details that are considered necessary or desirable. Optionally, the plan may additionally specify a time (preferably defined again relative to an assumed start time of t=0) at which the drone is to pass through each of the waypoints.

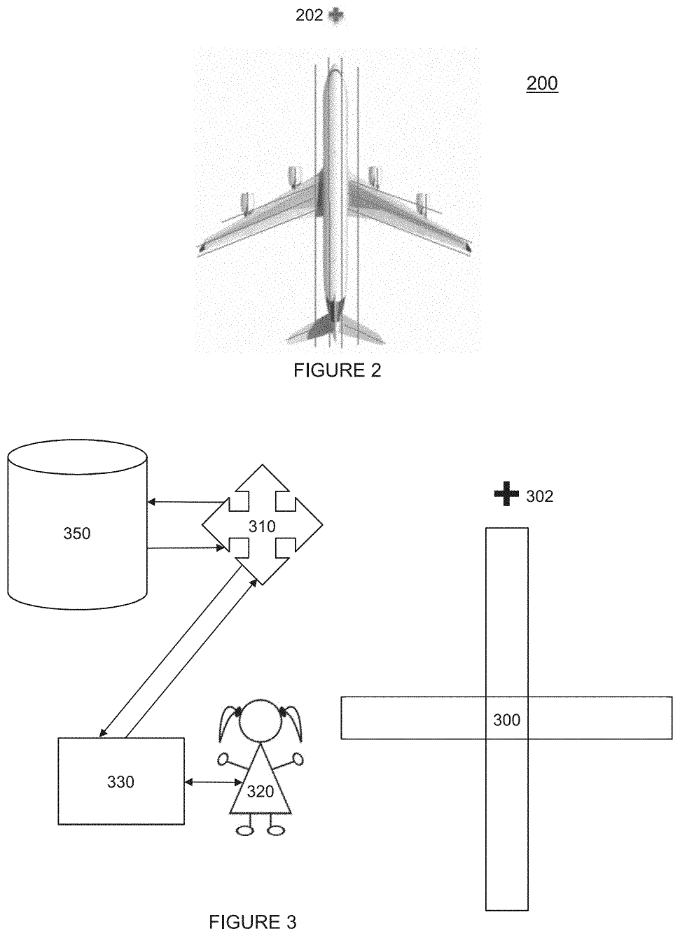

In this way, a network of points and to visit and the route through them is specified, such as that illustrated schematically in FIG. 2. FIG. 2 shows a simplified, illustrative flight path that a drone might follow to perform an inspection of an entire aircraft 200. The cross 202 immediately ahead of the nose cone of the plane represents the origin position for the inspection path in this example.

In practice and in dependence, among other things, on the specific UAV technology chosen in any particular application, it may be preferred to define the flight plan in terms of sequences of movements and actions for the drone to follow, as opposed to simply recording the spatial (and time) co-ordinates to be visited. In other words, rather than a simple list of displacement vectors, the file defining the flight plan may include a sequence of instructions of the form “move in the x direction by an amount y”.

The flight plan thus created may be stored to a database for retrieval at inspection time, as will be discussed in more detail below.

Database Generation

As mentioned, sub-inspections (that is, inspections of isolated parts of) many aircraft models are commonly required in the airline industry. According to aspects of the invention, corresponding flight plans for a camera-equipped drone may be created and stored in a similar manner to that just described. These may assume the same start position for the drone as the more comprehensive routines, for consistency; alternatively, a different home position may be chosen suitably for the nature of each sub-inspection. For instance, when defining a flight plan corresponding to an inspection of a single wing, it may be more appropriate to define the waypoints to be visited relative to an origin that is 1 m from the wing tip than in relation to the nose of the craft.

By repeating this process to create flight plans corresponding to all inspection routines required, of all aircraft makes and models of interest, a database of plans may be created and stored. Preferably, all each plan created are saved under a name that allows easy identification and access later on. For instance, each file name may include an indication of the make and model of the aircraft to which it relates, followed by a unique identifier of the portion(s) of the craft covered by the inspection routine defined. This information may be included in the file names either literally in the form of words, or else according to some pre-defined numeric or alphanumeric coding. In preferred embodiments, the database is stored in a secure, remote ‘cloud’ infrastructure to which all airlines, airports and ground handlers may be given secure access. This brings the advantage that any necessary changes to one or more of the stored flight plans only need to be effected once in order for all users, no matter their location on the globe, to have access to the updated version of those file(s). Access to the information stored in the cloud is preferably controlled by means of a suitable privacy framework.

The inspection routines that are stored may relate to different parts of a specific aircraft, such as a given wing or a tail plane. The may also include inspections for different purposes. For example, an inspection may be routine and required after a given number of flying hours or may be in response to an incident that has been reported during a flight, for example a lightning strike. In the latter case it is likely that the aircraft will need to be examined at some airport remote from the airline's usual facility where ground view and facilities are limited. Embodiments of the invention have the advantage that limited inspections of part or the aircraft may be performed remotely with the UAV controlled by an operator that is not present at the aircraft, thereby reducing the number of people required on the ground and making more feasible to inspect aircraft at any location.

Alternative

Given the required precision of the UAV flight plans, discussed above, and further in view of the considerable variety of aircraft makes and models in service in the passenger airline industry, it is anticipated that the initial creation of a complete plan for each and every routine required may become a lengthy and tedious process. Therefore, the invention envisages embodiments in which an initial flight plan for each type of inspection that is expected to be automated using unmanned drones (for example, a comprehensive D check; a lighter A check; or an isolated inspection of a single wing) may first be generated and defined in generic terms; that is, in terms of unreferenced physical parameters corresponding to any dimensions that vary from one species of craft to the next. For instance: within any inspection that encompasses coverage of one or both wings of a plane, a drone may be required to move a distance in the horizontal plane (that is, the plane parallel to the ground) that corresponds to the length of the wing. Since wing length is aircraft-specific, the initial (or ‘master’) plan may recite a corresponding abstract variable representing it, rather than any one number.

This generic, template flight plan for a particular check may then be used create complete sets of specific instructions that a drone can follow to carry out that check on any particular craft, simply by pulling in the relevant dimensions.

The dimensions of all aircraft of interest may be stored, along with any other relevant data, in a suitable, pre-populated database, maintained again in a central cloud storage infrastructure and accessible by all relevant parties.

As will be appreciated, such an approach may drastically reduce the time and effort required to create a complete database including inspection plans corresponding to all required checks of all makes and models of aircraft, since it concentrates much of the work that would be required to generate an aircraft-specific UAV flight plan (such as defining which points of the craft should be visited, which components imaged, and so on) into an initial, one-time process. Subsequent population of the database by substituting the relevant numerical dimensions for each species of craft is susceptible to automation by a suitable computer code, for instance, and may require comparatively little human input.

This population may be done as a one-time or initial process, importing the dimensions of each aircraft make and model in turn and saving the resultant flight plans into a complete database as above, as though they had been created ab initio. Alternatives are envisaged in which a drone itself, at inspection time, may import the generic flight plan together with the relevant data to create a one-time plan that is tailored to the inspection mission to be completed.

Inspection Time

When it comes to inspection time, a number of possible procedures are foreseen. One, specific example will be given for concreteness; the variations on certain steps of that method will then be described in turn.

FIG. 3 illustrates schematically the exchange of information and other interactions that may occur prior to initialising inspection of an aircraft 300 by a drone 310.

As shown, a drone operator 320 may be equipped with a computing device 330. Device 330 may be a fixed personal computer or, alternatively, a network-enabled mobile device such as a laptop computer, a tablet computer, or a smart phone, and may include a suitable application for interfacing with the drone as described below.

The operator 320 and her device 330 may be in the same physical location as the aircraft 300 and the drone 310. Alternatively, the operator 320 may be situated remotely, for example at a different location at the airport. This may advantageously reduce any security checks required of the operator where the craft 300 is located in a section of the airport having access restrictions, for example. The embodiments are particularly advantageous where the aircraft is at a location where the operating company has few resources, for example away for the airline's main airports. The embodiment to be described can be performed using minimum personnel at the site of the aircraft with the inspection drone controlled and operated remotely, for example at the airlines maintenance headquarters which may be thousands of kilometres away.

As a preliminary step, the aircraft to be inspected needs to be identified, either generically to identify the type of aircraft, or specifically to identify the individual aircraft. This may be performed remotely by the camera equipped drone which can capture an image of the aircraft which can then be matched, either automatically through pattern recognition, or by a human operator to determine the generic aircraft type. Alternatively, the camera can capture an image of a unique identifier such as the aircraft tail number which can be used to select and accept the correct flight plan for the particular aircraft taking into account the aircraft type and the maintenance history of the individual aircraft.

In the present embodiment, the operator 320 may use the application software to interface with a database 350 of drone mission plans, such as that described above. The operator may search through the database for the file corresponding to the required inspection of the particular make and model of aircraft 300, and import that file to device 330. The operator may then use the application to upload the retrieved mission plan to the autopilot of drone 310.

The operator, where co-located with the craft 300, may then place the drone at the home position 302. (Where the operator 320 is not physically situated at the inspection location, this may instead be done by any member of airline ground staff or other authorised personnel having access to that location.) The drone may then take off, perform the data collection required of it to identify the aircraft and then to inspect a portion of the aircraft as instructed by the downloaded flight plan, making appropriate use of on-board sensors to monitor its own position and in particular its distance from the aircraft surface, and land. The collected data may be saved locally to the drone's hardware, and later accessed and retrieved by the operator 320 once the inspection flight is complete. Alternatively, the drone may actively send the data back to device 330, either again in a single operation at the end of its mission or else in real-time. Additionally or alternatively, a copy of the mission results may also be sent to the database 350, either by the drone 310 or by the operator 320, for future analysis.

The purpose of the scan is to identify points on the surface of the aircraft that may warrant further investigation. Accordingly, during the inspection the system captures data indicative of the condition of points of the structure that correspond to the positions in three-dimensional space visited by the drone. Points are identified where the condition is sub-optimal. This may be by a visual inspection by the operator or automatic by use of image comparison software. The system records points identified as sub-optimal and saves the coordinates of those points. When the initial inspection has finished the operator controls the drone to revisit the saved points to perform a further inspection. This further inspection may be more detailed and, for example may involve the drone flying at a different distance to the surface of the aircraft from the initial inspection.

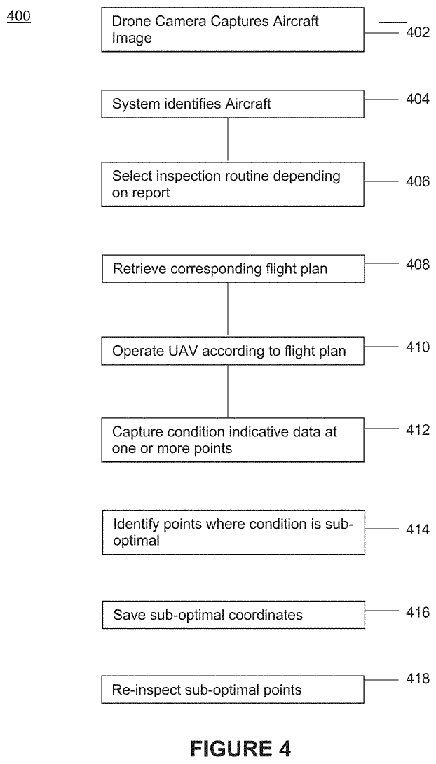

FIG. 4 is a flow chart 400 showing this process. At step 402 the drone is lunched by a local operator to enable the drone camera to capture an image of the aircraft to enable it to be identified, for example the tail number of the aircraft. That image is passed to the system and identification performed at step 404. At step 406, a specific inspection routine is selected from a plurality of available inspection routines in accordance with the maintenance report.

At step 408 a flight plan for the UAV corresponding to the selected inspection routine is retrieved from the database, the flight plan corresponding to the identified mobile structure and comprising instructions to visit positions in three-dimensional space corresponding to the points of the structure identified for inspection in the inspection routine. At step 410, the UAV is operated according to the flight plan and during that operation, at step 412, the UAV, at one or more of the positions visited, captures data indicative of the condition of the corresponding point of the structure. At step 414, the condition of these captured points is analysed, either automatically or manually to identify points where the condition of the structure is sub-optimal and the coordinates of any points so identified are saved at step 416. When the inspection have finished, the UAV operator at step 418 instructs the drone to perform a further inspection of the points that have been identified as sub-optimal and these points are retrieved and visited by the drone. The further scan can be more detailed, for example with the drone a different distance away from the surface of the aircraft, as instructed by the operator.

Though not presently the case, the inventors foresee the possibility that the use of drones and other, similar technology in airports may in the future require special security and approval procedures. It is probable that such procedures will depend, among other factors, on the local law in the particular country in which the inspection is to be performed. In such cases (or optionally, otherwise), the operator may send the flight plan imported from the database 350 to the appropriate approval authority for clearance before uploading it to the drone 310. As an alternative, it may be sent by the drone autopilot software once downloaded and before taking off to perform the prescribed inspection. Approval in that case may be communicated either back to the drone or to the operator (for example, via her device 330) or other ground staff, who may then position the drone at the home point ready to begin its inspection flight.

Optionally, the exact position of the drone at all times during its mission flight may be relayed to any eventual approval authorities. Again optionally (or compulsorily where required by local regulations), the aircraft-specific flight plan downloaded from database 350 by operator 320 may be modified or altered as needed to take account of any particular requirements of the local jurisdiction before the drone is allowed to take off. In the event of an incident or a meteorological event, a local airport may implement a temporary no-fly zone, such that an expected start time for an inspection may need to be delayed until permission is given for the drone to fly. Similarly, specific details particular to the inspection location may need to be taken into account and the flight plan modified accordingly. For instance, obstacles that cannot be displaced will need to be taken into account and worked around. This may be especially relevant where a drone is used to aid a pre-flight survey of a craft at an airport gate, where flight space may be limited or more restricted. Similarly, if the inspection is to take place in a covered hangar then allowances may need to be made for the construction details of that space.

Variations

The example just described assumed the drone's flight to be autonomous. This need not necessarily be the case however: the inspection may also be controlled manually, the operator 320 directing the drone 310 according to the flight plan using her mobile application, and monitoring its position to ensure correctness and completeness of the inspection process.

In the procedure described above, the operator 320 is responsible for retrieving the appropriate mission plan and uploading it to the drone 310. In one immediate alternative, the operator may instead use the application on her device 330 to instruct the drone to interface directly with database 350 to download the appropriate file to its autopilot system. In this case, she may communicate to the drone's software the make and model of the craft to be inspected and the specific inspection routine required. Alternatively, as a still further variation, compatibly with its capabilities the drone may ‘read’ the tail number of the aircraft, and determine the corresponding craft (and thus, the appropriate inspection routine file to be retrieved) by querying an aircraft registry that contains a list of all aircraft types and models with a reverse look-up.

As was mentioned above, in some realisations the database 350 may include a limited number of generic flight plans (for example, one for each type of inspection that may be required), cast in terms of unreferenced parameters the values of which vary from one plane to the next. This may result in a more efficient use of computational storage: since, as a result of the detail required, the flight plans are expected to be large data files, the ability to store a single file of instructions that can enable (for instance) an A check, instead of one for each type of aircraft that may need to be inspected, may result in a significant saving in the storage space required. In these embodiments, the operator 320 may retrieve the file corresponding to the inspection that she wishes to carry out, and populate this with the appropriate data to generate a set of specific instructions that she can then communicate to the drone 310 as described above.

The various software and communications described herein may be implemented using any appropriate functionality. In some embodiments, the application used by the operator 320 to interact with the autopilot software of the drone 310 may be a JavaScript application. The database 350 may be stored on a remote server. Communications may be realised according to the Hypertext Transfer Protocol (HTTP), for example, and may make use of any wireless local area network that may be available. Alternatively, communications may take place across a third, fourth or fifth generation wireless mobile telecommunications technologies.

1. A method for automated or semi-automated inspection of a large, mobile structure using a camera-equipped unmanned aerial vehicle, UAV, the method comprising:
using the camera to identify the mobile structure to be inspected;
selecting an inspection routine for a portion of the mobile structure from a plurality of available inspection routines;
retrieving, from a database, a flight plan for the UAV corresponding to the selected inspection routine, the flight plan corresponding to a portion of the identified mobile structure and comprising instructions to visit positions in three-dimensional space corresponding to points of the structure identified for inspection in the inspection routine;
operating the UAV according to the retrieved flight plan;
at one or more of the positions visited, capturing data indicative of a condition of a corresponding point of the structure;
identifying points of the structure where the condition of the structure appears sub-optimal;
saving the coordinates of points of the structure so identified; and
on completion of the inspection, revisiting one or more points identified as sub-optimal and performing a further inspection under the control of an operator.

2. The method of claim 1, wherein the captured data comprise image data.

3. The method of claim 1, wherein the captured data comprise video data.

4. The method of claim 1, further comprising transmitting the captured data to an operator for analysis.

5. The method of claim 4, wherein the transmitting is performed substantially in real-time as the data are captured.

6. The method of claim 4, wherein the transmitting is performed after the completion of the inspection flight plan.

7. The method of claim 1, wherein, the step of using the camera to identify the mobile structure to be inspected comprises capturing a unique identifier on the structure.

8. The method of claim 7, wherein the mobile structure is an aircraft and the unique identifier is an aircraft tail number.

9. The method of claim 1, wherein the flight plan maintains the UAV at a predetermined distance from a surface of the mobile structure, determined by the selected inspection routine.

10. The method of claim 1, wherein the step of identifying points of the structure where the condition of the structure appears sub-optimal is performed automatically by comparison of data retrieved by the camera with pre-stored data for the respective point of the mobile structure.

11. The method of claim 1, wherein the step of identifying points of the structure where the condition of the structure appears sub-optimal is performed by a human operator.

12. A system for automated or semi-automated inspection of a large, mobile structure, comprising:
a camera-equipped unmanned aerial vehicle (UAV);
a database having stored therein a plurality of inspection routines, and a three-dimensional rendering of a plurality of mobile structures; and
a controller, the controller being programmed perform the steps of:
controlling the UAV camera to identify the mobile structure to be inspected;
selecting an inspection routine for a portion of the mobile structure from a plurality of available inspection routines;
retrieving, from the database, a flight plan for the UAV corresponding to the selected inspection routine, the flight plan corresponding to a portion of the identified mobile structure and comprising instructions to visit positions in three-dimensional space corresponding to points of the structure identified for inspection in the inspection routine;
operating the UAV according to the retrieved flight plan;
at one or more of the positions visited, capturing data indicative of a condition of corresponding point of the structure;
identifying points of the structure where the condition of the structure appears sub-optimal;
saving the coordinates of points of the structure so identified; and
on completion of the inspection, revisiting one of more points identified as sub-optimal and performing a further inspection under the control of an operator.

13. The system of claim 12, wherein the controller is programmed to control the camera to identify the mobile structure to be inspected by capturing a unique identifier on the structure.

14. The system of claim 13, wherein the mobile structure is an aircraft and the unique identifier is an aircraft tail number.

15. The system of claim 12,wherein the flight plan maintains the UAV at a predetermined distance from [[the]]a surface of the mobile structure, the predetermined distance determined by the selected inspection routine.

16. The system of claim 12, wherein the controller is programmed to perform the step of identifying points of the structure where the condition of the structure appears sub-optimal is performed automatically by comparison of data retrieved by the camera with pre-stored data for the respective point of the mobile structure.

17. The system of claim 12, wherein the identification of points of the structure where the condition of the structure appears sub-optimal is performed by a human operator.
